(19) United States
(12) Patent Application Publication
(10) Pub. No.: US 2017/0346321 A1
(43) Pub. Date: Nov. 30, 2017

(54) Disposable Charger for a Mobile Electronic Device

(71) Applicant: David Lemberg, Los Angeles, CA (US)

(72) Inventor: David Lemberg, Los Angeles, CA (US)

(21) Appl. No.: 15/167,976

(22) Filed: May 27, 2016

(51) Int. Cl. H02J 7/00; H04W 88/02

(52) U.S. Cl. CPC H02J 7/0045; H02J 7/0052; H04W 88/02; H02J 2007/0062

(57) ABSTRACT

The proposed disposable charger for a mobile phone or the like comprises a pack of two thin flat batteries which are arranged side by side and have outwardly projecting positive and negative contacts. The batteries are identical but overturned relative to each other whereby their positive contacts are located closer to each other near the adjacent sides of the batteries while the negative contacts are located remotely to each other. Since the contacts are coplanar with the surfaces of the batteries, a gap is formed between the contacts of both batteries. Inserted into this gap is a double-sided printed circuit board with a wiring that interconnects the contacts of the batteries in an appropriate manner. The batteries and the printed circuit board are sandwiched and fixed between the base plate and the cover of the charger.

### FIELD OF THE INVENTION

The present invention relates to a disposable charger for mobile electronic devices, and specifically to mobile phones, or the like.

### BACKGROUND OF THE INVENTION

One of the biggest complaints people have about their mobile electronic devices, especially smart phones, is an insufficient time for maintaining the battery in a charged state. For many people, just making it through the day can be a challenge. Various recommendations for lasting the usage time of the battery such as dimming the screen, turning-off animations, turning-off location services (GPS), manually updating the applications, etc., are inconvenient and in majority of cases are neglected.

Therefore, the users prefer to use portable battery chargers that can be carried by the user together with the electronic device, e.g., a smart phone, and can be used for charging the main battery of the device when the charge of the device battery has expired.

Many telephone charges of the aforementioned type are known. For example, US Patent Application Publication 20140232342 Published on Aug. 21, 2014 (Inventor: Randal Scott Turner) discloses a portable motion activated cell phone charger utilizing a shelled torus permanent magnet generator to generate electricity by kinetic energy imparted by the user if strapped to the arm or leg when jogging or may also be waved in the hand in an oscillating motion to generate electricity which is stored in a rechargeable battery within the charger assembly of which has a control circuit board with universal serial port attached and accessible from the exterior body casing allowing the user to connect a cell phone or small electronic devices with a universal serial bus cable to power the device or charge a battery within said device.

U.S. Pat. No. 6,977,479 (issued on Dec. 20, 2005 to Hsu Po-Jung John) discloses a portable cell phone battery charger using solar energy as the primary source of power. The charger includes two separate solar panels and a battery/switch containing unit. The two panels are hingedly connected together, and the battery/switch containing unit is hingedly connected to the back side of one of the panels. The assembly is pivotable between a retracted configuration in which the three component parts lie in parallel planes, and a deployed configuration in which the two solar panels lie in one plane and the battery/switch unit lies in another plane angularly intersecting the solar panel plane. The device is selectively operable in three different modes; namely, a first mode in which the solar panels are connected to charge or power a cell phone; a second mode in which the solar panels are connected to charge the device's internal battery, and a third mode in which the internal battery is used to charge or power a phone coupled to the device.

U.S. Pat. No. 8,204,551 (issued on Jun. 19, 2012 to Chih Hsing Lee) discloses an attachable battery pack having a battery body with a pivoted clamp for detachably fastening to one end of an intelligent cell phone (iPhone or Googlephone) as a spare battery. The battery body is configured to overlay the display screen of the intelligent cell phone to provide protection for the display screen and includes a charging circuit and connector for charging the built-in battery of the intelligent cell phone.

Vanguard Communications produces and sells a portable power charger known as Vanguard SmartPower Card which is used as an external power bank having a built-in Micro USB and Apple Lightning Cable. The device has a compact size and has a shape of a thin small panel that can be temporarily attached to the flat surface of a mobile phone and electrically connected to the mini-USB socket of a tablet, phone, or the like. The device uses lithium polymer battery.

However, practically all known chargers are accumulator-type chargers which are rechargeable and reusable. They need to be carried out and stored by the user for multiple use and therefore require an additional storage space. And even if the Vanguard SmartPower Card can be stacked onto the phone and carried with it as a single unit, this charger is relatively expensive, intended for multiple use and still cannot be discarded.

Chinese Patent Publication CN 2469564 published on Mar. 23, 2001 (Inventor: CHENXU XIUFENG) discloses a battery charger for a mobile phone, which the inventors named as a disposable but in fact the device is not disposable as it has a permanent housing, wiring, and a plug for connection to a mobile electronic device, and a disposable part is comprised only of replaceable batteries which are replaced with new ones when expired, while the casing of the device remains reusable.

### SUMMARY OF THE INVENTION

The proposed disposable charger of the invention for mobile electronic devices, more specifically for mobile phones, comprises a pack of two thin flat batteries which are arranged side by side and have outwardly projecting positive and negative contacts. The batteries are identical but overturned relative to each other whereby their positive contacts are located closer to each other near the adjacent sides of the batteries while the negative contacts are located remotely to each other. Since the contacts are coplanar with the surfaces of the batteries, a gap is formed between the contacts of both batteries. Inserted into this gap is a double-sided printed circuit board with a wiring that interconnects the contacts of the batteries in an appropriate manner. The batteries and the printed circuit board are sandwiched and fixed between the base plate and the cover of the charger. The output cable of the charger has a charging plug for connection to the power input port of the telephone. The charging plug has a pin for an adapter that is to be selected for coupling the charger with an electronic device or telephone of a predetermined type. In the form supplied to the customer the charging cable is hidden inside the housing of the charger and the plug located at the end of the cable is fixed in a cutout formed at a corner of the housing so that prior to use the charger has a full rectangular shape.

### BRIEF DESCRIPTION OF THE DRAWINGS

FIG. 1 is a three-dimensional general view of the disposable charger of the invention.

FIG. 2 a three dimensional view of the disposable charger of FIG. 1 in a condition of charging a mobile phone.

FIG. 3 is an exploded view of the disposable charger of the invention.

FIG. 4 is a three-dimensional view of the disposable charger with the micro-USB charging plug extracted from the housing of the charger.

FIG. 5 is sectional view along the line V-V of FIG. 3.

### DETAILED DESCRIPTION OF THE INVENTION

The present invention relates to a disposable charger for mobile electronic devices, and specifically to mobile phones, or the like. For the sake of convenience, further the disposable charger will be considered in application to a mobile phone, although the invention is not limited only to phone applications.

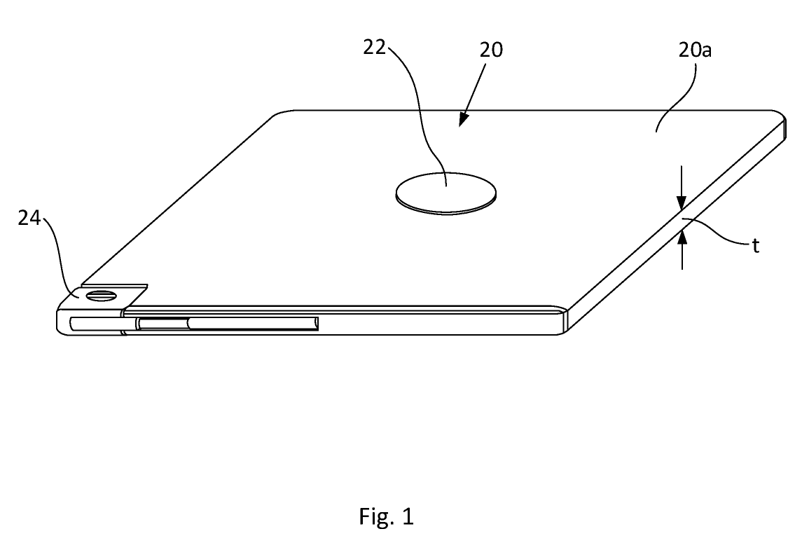

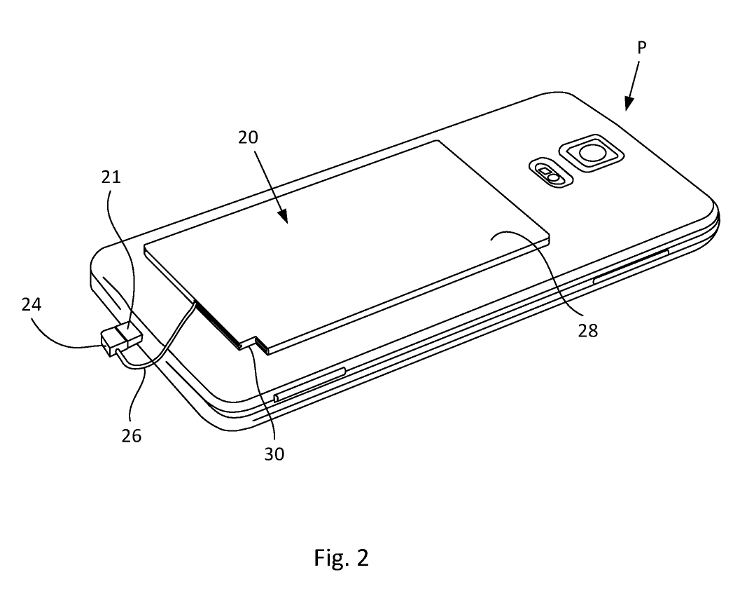

As shown in FIG. 1, which is a three-dimensional general view of the disposable charger 20 of the invention (hereinafter referred to merely as a disposable charger), the device 20 looks like a thin flat panel of a rectangular shape with smooth edges and rounded corners. When the disposable charger 20 is placed onto the back flat surface of the mobile phone (see FIG. 2, which is a three dimensional view of the disposable charger 20 in a condition of charging a mobile phone P), the charger 20 does not go beyond the contours of the phone P and in a top view may have dimensions equal to or smaller than the top overall dimensions of the phone P. The disposable charger 20 is thin, light in weight, and may have a thickness “t” (FIG. 1), e.g., in the range of 1 mm to 10 mm. It is' understood that this range is given as an example and the actual thickness depends on the type of batteries and the type of the object to be charged (phone, cam coder, tablet, etc.). During the use, i.e., during the charging operation, the disposable charger 20 is intended for attaching to the flat surface of the mobile phone P and for this purpose is provided with a double-sided foam adhesive tape, or pad 22 (FIG. 1), e.g., a 5×3 m Round Double Sided Mounting Adhesive pad of Terapeak Co., Ltd, CA, USA.

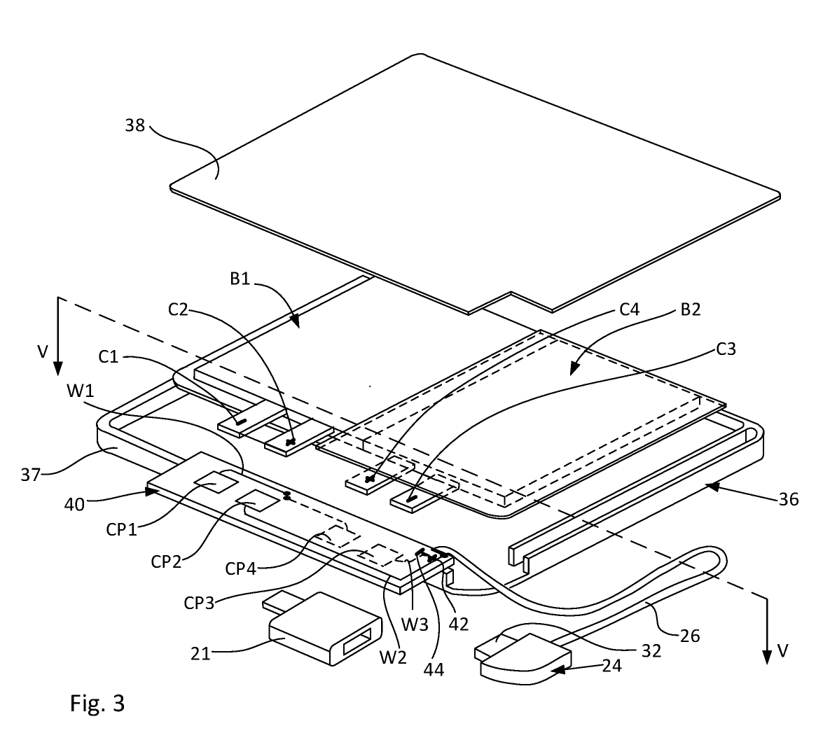

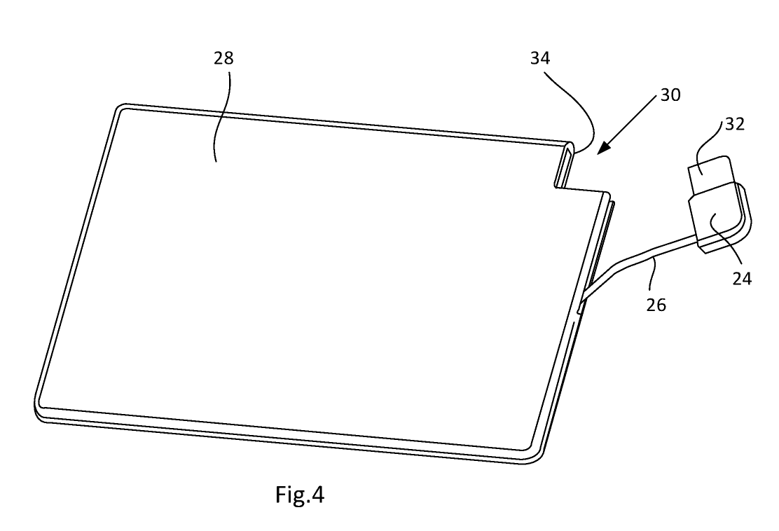

The disposable charger 20 is provided with a micro-USB charging plug 24 connected by a cable 26 to charging batteries B1 and B2 shown in FIG. 3, which is a three-dimensional exploded view of the disposable charger 20. Along with the double-sided adhesive pad 22, the disposable charger 20 is supplied with a micro USB Adapter 21 (FIG. 3), which can be fit onto the pin 32 of the charging plug 24 for connection to the power input port of the telephone (not shown). It is understood that by replacing the adapters 21, it is possible to electrically connect the disposable charger 20 to power input ports of telephones of different systems (i.e., i-phones, Android-system phones, etc.). One corner of a housing 28 (FIG. 2) of the disposable charger 20 has a cut-out portion 30 (see FIG. 4, which is a three-dimensional view of the disposable charger 20 with the micro-USB charging plug 24 extracted from the housing of the charger 20 for insertion into the input power port of the mobile phone P). Prior to use, the disposable charger 20 is supplied in a state in which the pin 32 of the plug 24 is inserted into a recess 34 which is formed in the end face of the cut-out portion 30 of the housing. As shown in FIG. 1, when the plug 24 is inserted into the disposable charger 20, it fills the space of the cut-out portion so that together with the rest of the charger it forms a complete rectangular configuration.

As can be seen from FIG. 3, the housing 28 (FIG. 4) of the disposable charger 20 consists of a base plate 36 in the form of a shallow open box with a vertical side wall 37 and a flat cover plate 38 which can be snuggly fitted into the base plate 36 so that in an assembled state of the housing 28 a space is formed between the cover and base for placing the batteries B1 and B2.

Although two batteries B1 and B2 are shown, it is understood that more than two batteries can be used without violation of the principle of the invention.

Each battery has a positive contact and a negative contact. The batteries are identical and are arranged side by side but in a mutually overturned position so that the front side of one of them becomes coplanar with the back side of the other battery. Thus, the battery B1 has a negative contact C1 and a positive compact C2, while the battery B2 has a negative contact C3 and a positive contact C4. It should be noted that the contacts of both batteries are coplanar with the upper surfaces of the batteries, so that in an assembled mutually overturned positions of the batteries a gap is formed between the contact of both batteries, which in detail will be described below.

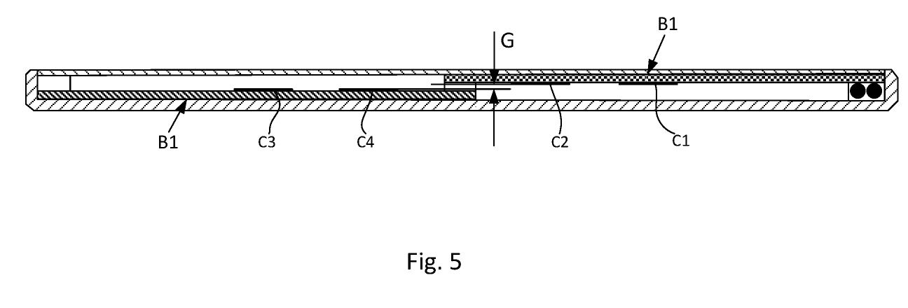

FIG. 5 is a sectional view along line V-V of FIG. 3, supposed that the disposable charger 20 is an assembled state. It can be seen that in an assemble state of the charger with the mutually overturned position of the batteries a gap G having a thickness D will be formed between the battery contacts C1, C2 and C3, C4.

A circuit wiring or a printed circuit board (PCB) 40 is placed into the gap G between the battery contacts C1, C2 and C3, C4 for connecting the negative contact C1 of the battery B1 with the positive contact C4 of the battery B2, the positive contact C2 of the battery B1 with the positive charge terminal 42; and the second negative contact C3 with the negative charge terminal 44 at the output of the printed circuit board 40.

The printed circuit board 40 is double sided and has contact plates CP1 and CP2 on the side that faces the contacts C1 and C2, respectively, of the first battery B1. On the side that faces the contacts C4 and C3, respectively, the printed circuit board 40 has contact plates CP4 and CP3. The contact plate CP1 is connected by wire W1 to the contact plate CP4, whereby the negative contact C1 of the battery B1 is connected to the positive contact C4 of the second battery B2. The second contact plate CP2 is connected by wire W2 to the positive output terminal 42 of the printed circuit board, and the contact plate CP3 is connected by wire W3 with a negative output terminal 44 of the board.

Although the invention has been described by way of a specific example with reference to specific drawings, it is understood that this example and drawings do not limit the invention and that any changes and modifications are possible within the scope of the attached patent claims.

1. A disposable charger for a chargeable mobile electronic device having a power input port and comprising: a plate-like housing consisting of a plate-like base and a plate-like cover; an electric plug for electrical connection of the charger with the mobile electronic device; at least a first electric battery having a first positive contact and a first negative contact and a second electric battery having a second positive contact and a second negative contact; and a circuit wiring that is placed between said first and second contacts for connecting via said wiring the first negative contact of the first battery with the second positive contact of the second battery, the circuit wiring having a positive output terminal and a negative output terminal; the second positive contact of the first battery with the second positive contact of the second battery, the first positive contact of the first battery with the positive output terminal terminal; and the second negative contact with the negative output terminal of the electric plug.

2. The disposable charger for a chargeable mobile electronic device according to claim 1, wherein the circuit wiring is a printed circuit board and wherein the at least the first electric battery, the second electric battery, and the printed circuit board are sandwiched between the plate-like base and the plate-like cover and fixed by clamping or by molding.

3. The disposable charger according to claim 2, wherein the first electric battery and the second electric battery are arranged side by side but in overturned positions to each other so that the positive contacts of the first electric battery and of the second electrical battery are positioned closer to the adjacent sides of the batteries than the negative contacts which are located closer to the opposite sides of the first electric battery and of the second electrical battery.

4. The disposable charger according to claim 3, wherein a gap is formed between the contacts of the first electric battery and the contacts of the second electric battery, and the printed circuit board is inserted into said gap between the batteries.

5. The disposable charger according to claim 4, wherein the printed circuit board is a double-sided printed circuit board that has a positive output terminal and a negative output terminal and comprises: a first contact plate that is in electrical contact with the negative contact of the first battery; a second contact plate which is in electrical contact with the positive contact of the first battery; a third contact plate that is in electrical contact with the negative contact of the second battery; and a fourth contact plate which is in electrical contact with the positive contact of the second battery; the first contact plate being electrically connected to the third contact plate; the second contact plate being electrically connected to the positive output terminal; and the fourth contact plate being electrically connected to the negative output terminal.

6. The disposable charger according to claim 1, wherein the chargeable mobile electronic device is a mobile phone.

7. The disposable charger according to claim 3, wherein the chargeable mobile electronic device is a mobile phone.

8. The disposable charger according to claim 5, wherein the chargeable mobile electronic device is a mobile phone.

9. The disposable charger according to claim 5, further comprising a micro-USB charging plug with a cable that connects the micro-USB charging plug with the positive output terminal and a negative output terminal of the printed circuit board.

10. The disposable charger according to claim 9, wherein the micro-USB charging plug has a pin and housing has a cutout portion at the corner of the housing with a recess in the end face of the cut out for insertion of the pin.

11. The disposable charger according to claim 10, wherein the end face of the cutout portion has a recess for insertion of the pin of the plug.

12. The disposable charger according to claim 11, wherein the plug has a shape fills the space of the cutout portion when the pin is inserted into the recess so that together with the rest of the charger housing the plug forms a complete rectangular configuration.

13. The disposable charger according to claim 12, further comprising an adapter for connecting the plug to the power input port of the mobile electronic device.

14. The disposable charger according to claim 6, further comprising a micro-USB charging plug with a cable that connects the micro-USB charging plug with the positive output terminal and a negative output terminal of the printed circuit board.

15. The disposable charger according to claim 14, wherein the micro-USB charging plug has a pin and housing has a cutout portion at the corner of the housing with a recess in the end face of the cut out for insertion of the pin.

16. The disposable charger according to claim 15, wherein the end face of the cutout portion has a recess for insertion of the pin of the plug.

17. The disposable charger according to claim 16, wherein the plug has a shape fills the space of the cutout portion when the pin is inserted into the recess so that together with the rest of the charger housing the plug forms a complete rectangular configuration.

18. The disposable charger according to claim 17, further comprising an adapter for connecting the plug to the power input port of the mobile electronic device.
